(19) United States
(12) Patent Application Publication
(10) Pub. No.: US 2017/0053217 A1
(43) Pub. Date: Feb. 23, 2017

(54) SYSTEM AND METHOD FOR INCREASING UTILIZATION OF CAPACITY LIMITED AND PERISHABLE EVENTS

(71) Applicant: Arif Pardesi, Dubai (AE)

(72) Inventor: Arif Pardesi, Dubai (AE)

(21) Appl. No.: 15/234,864

(22) Filed: Aug. 11, 2016

Related U.S. Application Data
(60) Provisional application No. 62/203,802, filed on Aug. 11, 2015.

(51) Int. Cl. G06Q 10/02

(52) U.S. Cl. CPC G06Q 10/02

(57) ABSTRACT

A system and method may include querying an event management data repository in response to receiving a request of a member to participate in an event occurring on a certain date having excess capacity. The event membership data repository may be accessed to determine whether at least one personal factor exists, the personal factor(s) may be both non-event related and non-membership related. An excess capacity rank value of the member may be computed as a function of the event related factors, membership related factors, and personal related factors. A queue may be dynamically generated and updated in a ranked order of members. A communication may be made to the electronic device of the member that the member is ranked above a capacity threshold level in the queue that is indicative that the member can utilize the excess capacity of the event on the certain date.

### RELATED APPLICATIONS

This application claims benefit of U.S. Provisional Application Ser. No. 62/203,802, filed Aug. 11, 2015, entitled SYSTEM AND METHOD FOR INCREASING UTILIZATION OF CAPACITY LIMITED AND PERISHABLE EVENTS, the contents of which are hereby incorporated by reference in their entirety.

### BACKGROUND

There are a wide variety of events that have limited capacity that this often underutilized, and, hence, produce less revenue than desired for the operator or promoter of the event. In some industries, it is statistically predictable as to the capacity utilization. For example, capacity utilization of airline flights, hotel rooms, sporting events seating, and so on is relatively predictable on a mathematical basis (e.g., average airline capacity utilization is 87%). While advertising and promotion campaigns may help increase attendance of these “perishable” events (i.e., events that occur on specific dates and times), such advertising and promotion campaigns often do not achieve the desired results and can be costly from a marginal customer acquisition perspective.

In recent years, promotions in alternative sales channels have increasingly expanded due to the Internet, mobile devices, and other low-cost platforms to communicate directly with customers. In the case of the travel industry, travel websites, including traditional and “last-minute” and discount travel websites operated by aggregators of occupancy for events (e.g., sports tickets resellers) are often used to fill capacity of the perishable events. However, heretofore, the capacity filling channels, while beneficial to some extent, simultaneously tend to require deep discounting by the event operators.

Moreover, existing channels operate in a “vacuum” and utilize conventional protocols and historical paradigms in terms of communications to potential customers and execution techniques. For example, excess capacity distribution is generally performed closer toward the event and typically made available to a particular distribution list or, as understood in the art, published to a website for the general public to access the information (e.g., airplane tickets or hotel room reservations). As such, excess capacity distribution typically uses a “shotgun” approach that is generally unpredictable in its results, and leads to a “bottom feeder” mentality with consumers who simply wait to purchase tickets at the lowest price, thereby costing the operator or promoter money. Additionally, as a result of using conventional excess capacity distribution channels, consumers who purchase access to the excess capacity of the perishable events have little or no brand loyalty as they are simply looking for the least expensive pricing option.

### SUMMARY

To increase capacity utilization for an event and provide increased communication capabilities and brand loyalty to customers, a system may provide for data collection and processing techniques that enable efficiency for customers to participate in capacity utilization of perishable events. In one embodiment, data correlation and sensing techniques may be utilized across one or more communications platforms. The capacity utilization may be deemed “standby” capacity in which members may be able to use their membership to participate in an event based on their membership.

While the membership may provide the ability for members to attend an event on a standby basis, certain factors may enhance a member's ability to attend an event in a standby capacity. In one embodiment, the system may enable a user to utilize social media connections to fill excess capacity and increased status, at least on a short-term basis, for the members informing or being part of a social network on which at least a portion of the members of the social networks are also members of a membership for participating in an event. For example, a social network group, not necessarily located in local proximity to one another, may decide to meet in the destination location and the group of members may submit to respectively travel to the destination. As a result of traveling as a group, the system may temporarily increase status or raise priority for each of the members of the group in an effort to come to the members who are traveling to the destination location. Technical features and correlation metrics provide for such group identification and processing.

One embodiment of a system may include a storage unit configured to store (i) an event excess capacity membership group data repository inclusive of membership information associated with each member, a memory unit, an input/output (I/O) unit configured to communicate over a communications network, and a processing unit in communication with the memory unit and the I/O unit. The processing unit may be configured to query an event management data repository in response to receiving a request from an electronic device of a member of the event excess capacity membership group to participate in an event occurring on a certain date to identify at least one event on the certain date having excess capacity. The processing unit may further be configured to identify at least one event on the certain date with excess capacity. The event membership data repository may be accessed to determine whether at least one personal factor exists, where the personal factor(s) may be both non-event related and non-membership related. An excess capacity rank value of the member may be computed as a function of the event related factors, membership related factors, and personal related factors. The event management data repository may be queried to determine or estimate how many revenue customers will utilize the excess capacity of the identified at least one event with excess capacity, and a queue may be dynamically generated and updated in a ranked order of members who have requested to attend an event on the certain date. A communication may be made to the electronic device of the member that the member is ranked above a capacity threshold level in the queue that is indicative that the member can utilize the excess capacity of the event on the certain date.

One embodiment of a method may include querying an event management data repository in response to receiving a request from an electronic device of a member of an event excess capacity membership group to participate in an event occurring on a certain date to identify at least one event on the certain date having excess capacity. At least one event on the certain date with excess capacity may be identified. The event membership data repository may be accessed to determine whether at least one personal factor exists, the personal factor(s) may be both non-event related and non-membership related. An excess capacity rank value of the member may be computed as a function of the event related factors, membership related factors, and personal related factors. The event management data repository may be queried to determine or estimate how many revenue customers will utilize the excess capacity of the identified at least one event with excess capacity. A queue may be dynamically generated and updated in a ranked order of members who have requested to attend an event on the certain date. A communication may be made to the electronic device of the member that the member is ranked above a capacity threshold level in the queue that is indicative that the member can utilize the excess capacity of the event on the certain date.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an illustrative network environment in which excess capacity ad perishable events may be fulfilled and utilized;

FIG. 2 is an illustration of an illustrative event central reservation system (CRS) for providing central access to make event reservations;

FIG. 3 is an illustration of an illustrative event scheduling system for an event management group to perform event scheduling;

FIG. 4 is an illustration of an illustrative event management system for an event management group to perform event management;

FIG. 5 is an illustration of an illustrative event excess capacity system for determining and estimating event capacity;

FIG. 6 is an illustration of an illustrative event membership management system for providing event membership management and for assisting members with event booking;

FIG. 7 is an interaction diagram that provides an illustrative process for members of an event membership to participate in events with excess capacity;

FIG. 8 is a screen shot of an illustrative graphical user interface by which a member of an event membership can search for availability of an event, in this case an air travel event, that shows standby capacity on various flights with estimated excess capacity and the member's current ranking for being able to utilize the excess capacity;

FIG. 9 is a screen shot of an illustrative graphical user interface of a profile of a member to participate in excess capacity of events;

FIG. 10 is an interaction diagram inclusive of an illustrative process that provides for excess capacity membership customers to invite relationship members to an event with excess capacity;

### DETAILED DESCRIPTION

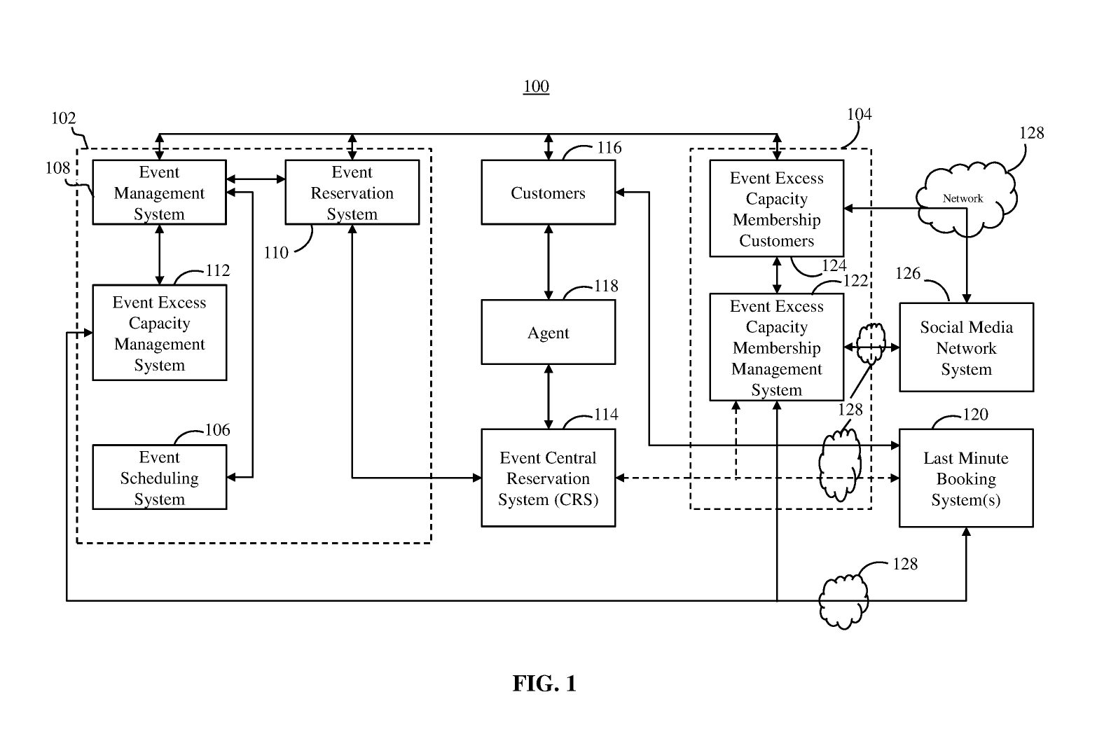

With regard to FIG. 1, a block diagram of an illustrative network environment 100 in which excess capacity ad perishable events may be fulfilled and utilized is shown. The network environment 100 may include an event platform 102 operated by an event management team or operator. In one embodiment, an event management platform 104 may be operated by an event membership management operator.

The event platform 102 may include an event scheduling system 106 used by the event management operator to schedule events. The events may include, but are not limited to, capacity limited and perishable events, such as airplane flights, sporting events, concerts, cruises, hotel rooms, rental cars, other rental systems (e.g., construction equipment) or venue (e.g., conference rooms), movies, or any other event that, if unutilized, will be a lost opportunity for the event management operator to fulfill with an audience or users. An event management system 108 may be configured to manage events by coordinating staff, logistics, equipment, and other aspects of an event. In the case of managing a flight, the event management system 108 may be configured to manage staffing (e.g., pilot, crew, baggage handlers), fuel, gates, food/beverages, attendees of scheduled events (e.g., passengers), and so on.

An event reservation system 110 may be configured to manage reservations for the event management operator for events being managed by the event management system. In managing reservations, the system 110 may be used to enable the event management operator to reserve space at the event directly or in conjunction with other reservations systems. An event excess capacity management system 112 may be in communication with the event management system 108 and used to compute or estimate excess capacity at scheduled events, as further described herein. The excess capacity determined by the system 112 may be a total excess capacity and/or specific types of excess capacity (e.g., certain types of seating).

In one embodiment, an event central reservation system (CRS) 114 may be utilized as a central reservation system for multiple event management operators (e.g., different airlines). Such an event CRS is typical for the airline, hotel, and other travel industries (e.g., cruises), but is not standard across many other industries. The event CRS 114 may be fed with scheduled events by an event management operator. The events may be provided by the event reservation system 110 or any other system (e.g., event scheduling system 106 or event management system 108).

Revenue customers 116, such as passengers, audience, or other customers, may be able to book or reserve attendance at an event via the event reservation system 110 of the event management operator or via an agent 118, such as a travel agent, ticket agent, or any other agent (e.g., ticket reseller), as understood in the art.

Last minute booking systems 120 have become commonplace with the growth of the Internet and Worldwide Web. Last minute booking systems 120 are very often used for the travel and accommodations industries to sell excess capacity of events. However, as previously described, the last minute booking systems 120 typically sell the excess capacity at significant discounts as compared to the prices that the event management operators sell the events. As a result, customers 116 have become “programmed” to wait for the discounts to be available on the last minute booking systems 120. Moreover, the customers 116 tend to be less brand focused when purchasing excess capacity from the last minute booking systems 120.

An event excess capacity membership management system 122 may be configured to provide for sophisticated technical system integration and data processing that supports managing event excess capacity membership customers or members with benefits to attend events, as described herein. The system 122 may provide for collecting and managing profile information provided by the customers 124. The profile information may include name, home location, contact information, such as addresses of electronic devices (e.g., phone number, email, etc.), preference information for events, geographically desirable destinations in the case of the events including travel (e.g., airline travel). In one embodiment, the system 122 may be configured to enable the customers 104 to store relationship information of friends, family, or others (e.g., work colleagues) for use in a member to invite others to join the member to join an event (e.g., travel to a destination location). The system may further be configured to communicate with and receive positioning information from the members and tracking systems of airplanes and the like so as to predict excess capacity and support such with the members. As shown, the system 122 may be optionally configured to enable customers 124 to book a reservation via the event CRS 114 and last minute booking systems 120. In particular, however, the system 122 may be configured to query the event excess capacity management system 112 (or another system that provides excess capacity information of events) to enable the customers 124 to be able to view what, if any, events are available for the customers 124 to participate.

A social media network system 126 may be any social media network system with which the customers 124 may utilize for social media activities, as understood in the art. In one embodiment, the system 122 may be configured to interact with the social media network system 126 to access social media contact information formed by the customers. As shown the various systems may communicate with one another via network 128, such as the Internet, as understood in the art.

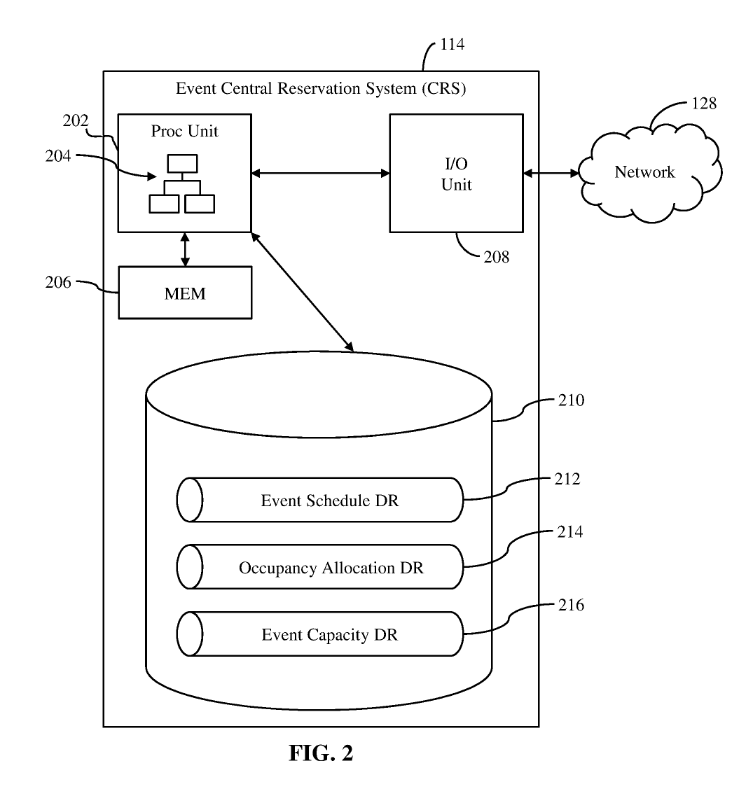

With regard to FIG. 2, an illustration of an illustrative event central reservation system (CRS) 114 for providing central access to make event reservations is shown. A processing unit 202 may be in communication with memory 206 configured to store data and software, input/output (I/O) unit 208 configured to communicate data over the communications network 128, and storage unit 210. The storage unit 210 may be configured to store data repositories 212, 214, and 216, which may be databases or otherwise.

An event schedule data repository 212 may be configured to store schedules of events being operated by an event manager or operator. As an example, an airline may schedule flights, and store those scheduled flights to enable a booking agent or other reseller to view and book the flights. Other examples of events that may use a system, either the same or different from one that manages flights are contemplated. For example, rental cars, cruise ships, hotel rooms, shows, concerts, restaurant seating, or otherwise may be managed by a CRS and may be supported hereby. The data repository may be populated with information describing potential capacity under-utilization as provided by a GDS system and/or travel management system.

An occupancy allocation data repository 214 may be configured to store data inclusive of allocation of occupancy of events. For example, a seating at an event that has been allocated to customers, such as passengers, resellers, or otherwise. An event capacity data repository 216 may be configured to store total capacity at events stored in the event schedule data repository. It should be understood that the data repositories 212-216 are illustrative, and that additional and/or alternative data repositories may be utilized by the event CRS 108. It should further be understood that the data repositories 212-216 may be combined or separated into different structures. The data repositories 212-216 may be configured as relational databases or use any other configuration, as understood in the art.

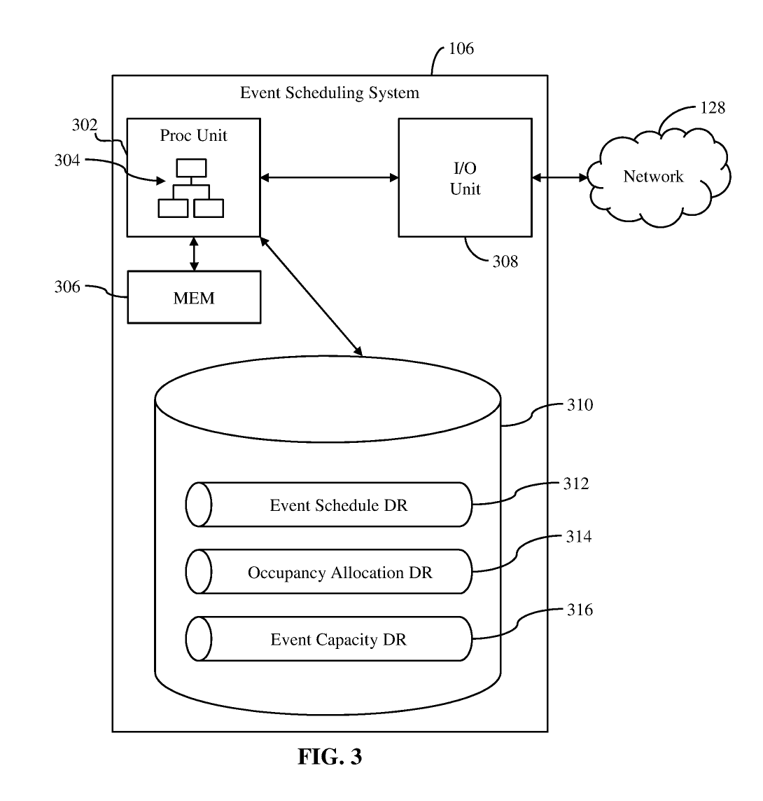

With regard to FIG. 3, an illustration of an illustrative event scheduling system 106 for an event management group to perform event scheduling is shown. A processing unit 302 may be in communication with memory 306 configured to store data and software, input/output (I/O) unit 308 configured to communicate data over the communications network 128, and storage unit 310. The storage unit 310 may be configured to store data repositories, which may be databases or otherwise. The data repositories 312-316 may perform the same or similar functions as the data repositories 212-216, but focused on events provided by a single event operator, as opposed to multiple event operators as was the case with the CRS system 114 of FIG. 2. It should be understood that the data repositories 312-316 are illustrative, and that additional and/or alternative data repositories may be utilized by the event scheduling system 106. It should further be understood that the data repositories 312-316 may be combined or separated into different structures. The data repositories 312-316 may be configured as relational databases or use any other configuration, as understood in the art.

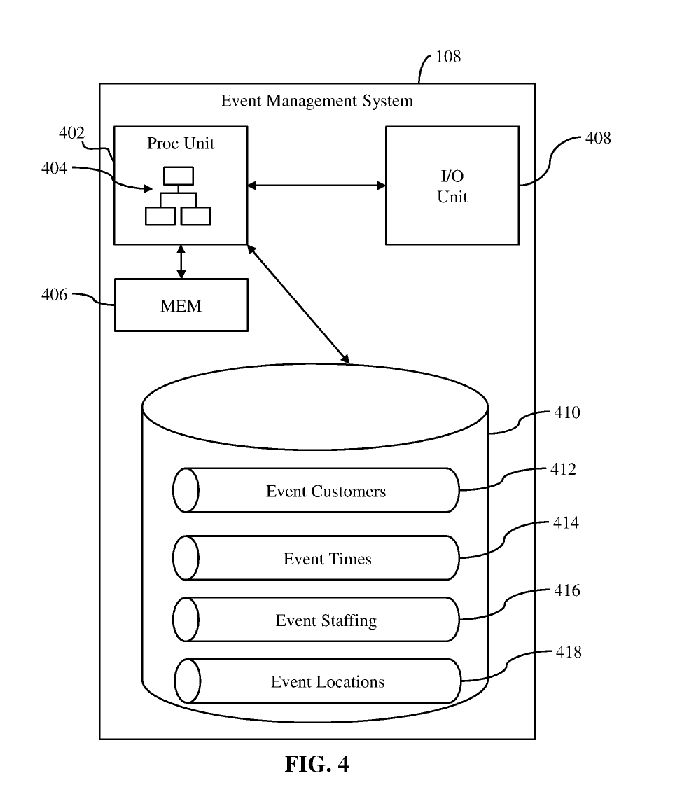

With regard to FIG. 4, an illustration of an illustrative event management system 108 for an event management group to perform event management is shown. A processing unit 402 may be in communication with memory 406 configured to store data and software, input/output (I/O) unit 408 configured to communicate data over the communications network 128, and storage unit 410. The storage unit 410 may be configured to store data repositories, which may be databases or otherwise.

An event customers data repository 412 may be configured to store customer information who are to attend events. The customer information may include identity information, status information, and/or other information (e.g., group information) of customers attending events. An event times data repository 414 may be configured to store dates and times at which events are scheduled and rescheduled. An event staffing data repository 416 may be configured to store staffing assignments for events, where the staffing may include staff that works at the event as well as staff that works prior to and after the event to ensure that the event is properly prepared and cleaned up. An event locations data repository 418 may be configured to store information indicative of where events are to occur. In the case of stationary venues, event locations are easily known. However, in the case of events that may move, such as airline flights, airports, terminals, and gates considerably vary and sophisticated algorithms and management tracking processes may be utilized. It should be understood that the data repositories are illustrative, and that additional and/or alternative data repositories may be utilized by the event management system 108. It should further be understood that the data repositories 412-418 may be combined or separated into different structures. The data repositories 412-418 may be configured as relational databases or use any other configuration, as understood in the art.

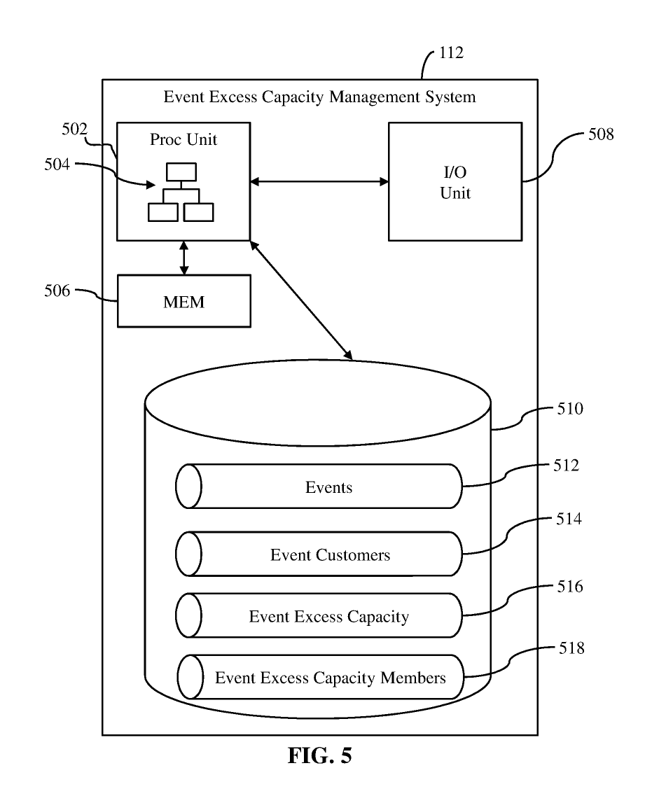

With regard to FIG. 5, an illustration of an illustrative event excess capacity system 112 for determining and estimating event capacity is shown. A processing unit 502 may be in communication with memory 506 configured to store data and software, input/output (I/O) unit 508 configured to communicate data over the communications network 128, and storage unit 510. The storage unit 510 may be configured to store data repositories, which may be databases or otherwise. An events data repository 512 may be configured to store information associated with events established by an events operator or promoter. The information may be derived from the event management system 108 of FIG. 4.

An event customers data repository 514 may be configured to store information associated with customers who are scheduled to attend events. Alternatively, the event customers data repository may be configured to store a total number of customers to be attending an event in addition to event capacity information, such as total number of seats available at an event venue (e.g., airplane flight, theater, sports venue). The event excess capacity data repository 516 may be configured to store excess capacity information for events. In one embodiment, excess capacity of an event may be refined to include revenue customers who may be standby customers (e.g., customers who have paid to attend a different event, such as a later event, but want to switch the event to which he or she want to attend).

An event excess capacity members data repository 518 may be configured to store information associated with event excess capacity members who have submitted requests to attend an event as part of his or her membership benefits. For example, if a member of an excess capacity membership requests to travel on a particular airplane flight (event), that information associated with that member may be stored in the data repository 518 so that the system 112 may use that information for scheduling purposes. It should be understood that the data repositories 512-518 are illustrative, and that additional and/or alternative data repositories may be utilized by the event excess capacity management system 112. It should further be understood that the data repositories 512-518 may be combined or separated into different structures. The data repositories 512-518 may be configured as relational databases or use any other configuration, as understood in the art.

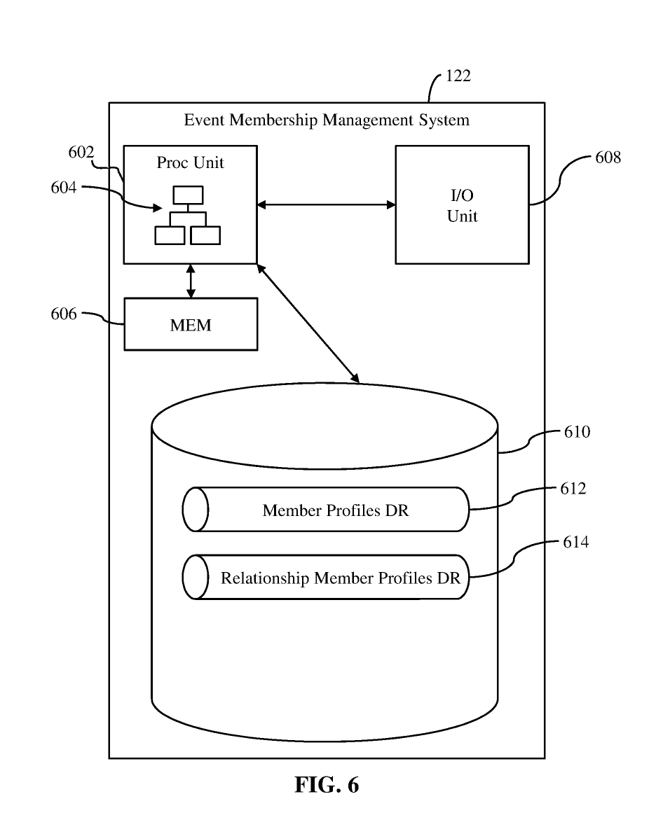

With regard to FIG. 6, an illustration of an illustrative event excess capacity membership management system 122 for providing event membership management and for assisting members with event booking is shown. A processing unit 602 may be in communication with memory 606 configured to store data and software, input/output (I/O) unit 608 configured to communicate data over the communications network 128, and storage unit 610. The storage unit 610 may be configured to store data repositories, which may be databases or otherwise.

A membership profiles data repository 612 may be configured to store profile information of members. The profile information may include member identification information and event qualified participation information. The event qualified participation information may include international flights, domestic flights, one airline, multiple airlines, one sports team venue, multiple sports team venue, one hotel brand, multiple hotel brands, theater days, event seating limitations (e.g., general admission, priority admission, etc.), and so on. A relationship member profiles data repository 614 may include information associated with individuals with whom the members have indicated or the system may identify, automatically or with assistance by respective members. The information may include contact information, work information, relationship information (e.g., family, friend, college friend, work colleague, etc.) to enable the system 122 to determine

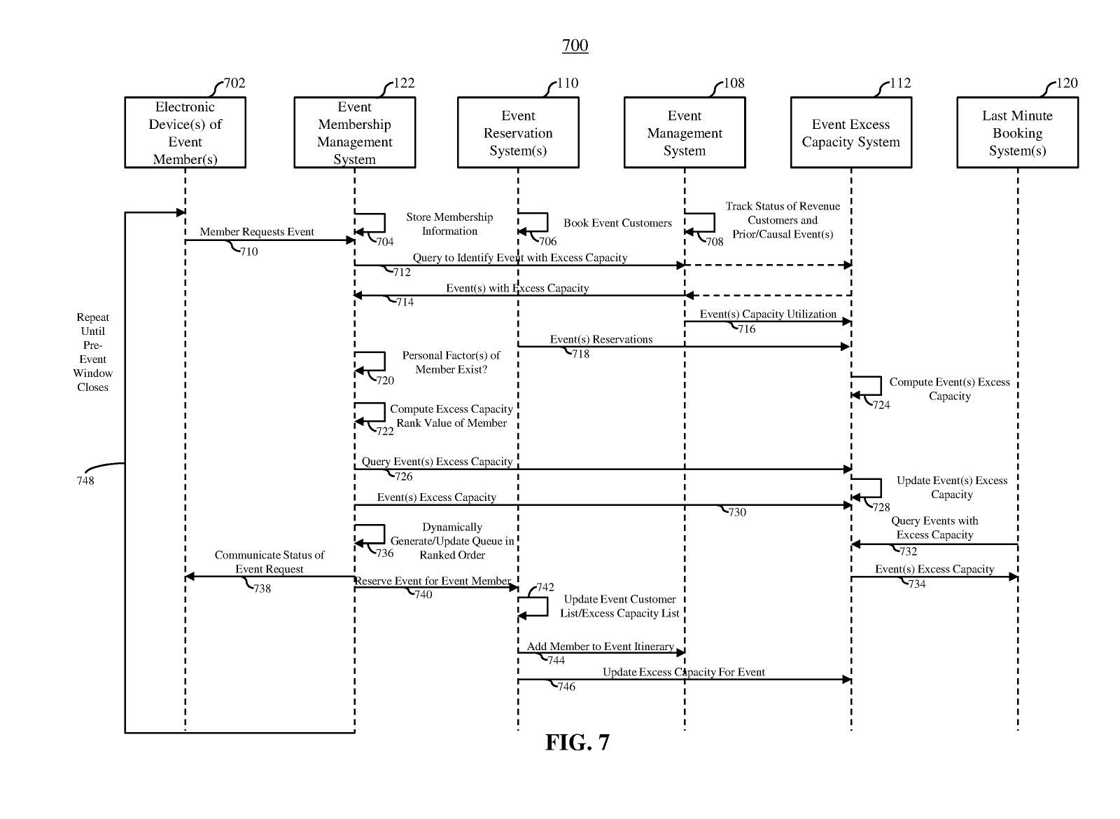

With regard to FIG. 7, an interaction diagram that provides an illustrative process 700 for members of an event membership to participate in events with excess capacity is shown. The process is shown to include electronic device(s) 702 of excess capacity event member(s), where the electronic device(s) 702 may include computing devices, communications devices, fixed location devices, mobile devices, or otherwise. The process 700 may start at step 704, where the event excess capacity member management system 122 may store membership information 704. The membership information may be generated and saved by respective members. In one embodiment, at least a portion of the membership information may be automatically generated through use of “crawling” algorithms, querying of other systems (not shown) that include public and/or private data records of individuals who are members or desire to become members, or otherwise. For example, home address information, family information (e.g., location of parents and siblings), relationship information (e.g., friends, colleagues, etc.), professional information (e.g., work information, travel schedule information, previous work information, etc.), educational information (e.g., high school, college, graduate school, etc.), historical information (e.g., home town, college town, previous address information), social information (e.g., social media account information, social media username information), or other information associated with members may be stored for use in providing membership services. Such membership services may include, but not be limited to, identifying available occupancy for transportation services (e.g., airplane, train, bus, ship, ferry), lodging (e.g., hotel, motel, ferry, timeshare, condominiums, etc.), entertainment venue services (e.g., sports, movies, plays, golf, boating, amusement parks, etc.), and so on.

At step 706, the event reservation system(s) 110 may be configured to book event customers to attend events. The event customers are considered revenue customers in that the customers pay to attend the events. At step 708, the event management system 108 may be configured to track status of revenue customers and prior/causal event(s). In tracking status of revenue customers, the system 108 may be configured to track whether customers cancel, miss, or attend their booked events, as customers who cancel or miss the events creates excess capacity for excess capacity membership members to attend the events. The prior or causal tracking may include determining that passengers miss a first flight segment, for example, thereby creating excess capacity on a second flight segment on which the passengers are booked. As an example, a travel passenger booked to fly from Los Angeles to London who cancels or misses a first flight segment from California to New York may create excess capacity on the flight from New York to London if the travel passenger cannot be rebooked to maintain the originally scheduled flight from New York to London, thereby enabling the excess capacity to be filled by another revenue customer, valued customer, last minute travel customer, or excess capacity membership customer.

At step 710, a member may request an event from the event excess capacity membership management system 122 via one of his or her electronic devices 702. The request may include parameters based on event types. For example, if the member is seeking to attend a sporting event, the type of sporting event, location of sporting event, specific team participating in the sporting event, and so on may be submitted. As another example, if the member is seeking transportation services, such as air travel services, the member may submit origination location, destination location, desired dates and times of travel, specific airline (if the membership allows for access on multiple airlines), number of stops, number of passengers (if the member has a family membership or companion travel membership), special occasion information (e.g., birthday, anniversary, religious holiday, school reunion, and so on), and any other travel and non-travel related information.

The non-travel related information may, at least in part, enable the event excess capacity membership management system 122 to improve ranking of the member to improve the chances of the member to fill excess capacity with respect to other excess capacity members, non-revenue customers, or, optionally, even certain types of revenue customers. For example, if the member is a valued customer (e.g., frequent flyer, frequent guest, etc.) of an event operator (e.g., airline, hotel chain), the status of the valued customer may improve the chances that the excess capacity member will receive the excess capacity and use the membership benefits as opposed to having to use valued customer reward points (e.g., frequent flyer miles). In response to receiving the member event request, the event excess capacity membership management system 122 may, in turn, query the event management system 108 and or event excess capacity system 112 to identify event(s) with excess capacity. At step 714, the event management system 108 and/or event excess capacity system 112 may return an response inclusive of event(s) with excess capacity. At step 716, the event management system 108 may communicate event capacity utilization information to the event excess capacity system 112. Alternatively, the event excess capacity system 112 may poll the event management system 108 to maintain up-to-date excess capacity status information. In one embodiment, at step 718, the event reservation system(s) 110 may communicate reservation information for one or more events of which an event operator is managing, thereby updating capacity information for the event excess capacity system 112.

At step 720, the event excess capacity membership management system 122 may determine if personal factor(s) of the member that would cause the system 122 to increase or otherwise alter a ranking (e.g., temporary or long term) for the member exists. The personal factors may be both non-event related and non-membership related. As an example, personal factors that are non-event related and non-membership related may include, but are not limited to, birthdays, anniversaries, religious holidays, school graduations, school homecomings, special events, and so on. The ranking may be computed using a variety of factors, including number of revenue flights taken by a member, number of excess capacity flights taken by the member, number of social media friends the member refers to be members, or any other historical statistic or membership increase that the member generates. As described above, the ranking is used for positioning excess capacity members to be provided with fulfilling excess capacity of an event with respect to other excess capacity members or non-members. In one embodiment, the system 122 may query or lookup any personal factor(s) in the member profiles data repository 612 of FIG. 6 or other data repository. In an alternative embodiment, the system 122 may identify a single piece of information, such as school that the member graduated, and perform a search of the school's website or other data repository to determine if a homecoming or other event is planned around the time that the member is seeking to travel. If one or more personal factor exist, then the event excess capacity membership management system 122 may include the personal factor(s) in computing excess capacity rank value of the member at step 722. The ranking of the member may be used in adding the member to an ordered list of other members who desire to participate in the same event.

At step 724, the event excess capacity system may compute and/or estimate excess capacity at one or more events. The computation or estimation may include using the event capacity utilization information received at step 716 along with any other information, such as tracking information of revenue customers of prior events, in the cases where status of a revenue customer may impact capacity utilization of a later event (e.g., multi-segment flight passenger).

At step 726, the event excess capacity membership management system 122 may query excess capacity of one or more events from the event excess capacity system 112. At step 728, the event excess capacity system may perform an update for the event(s) being queried. In an alternative embodiment, updating of excess capacity of events may be independent of the query of step 726. In response to the query of step 726, the event excess capacity system 112 may provide excess capacity information of the event(s) for which the event excess capacity membership management system 122 queried. The information may include event(s) having excess capacity and amount of excess capacity (e.g., number of available seats at a sporting event, number of available seats on an airline flight, etc.).

At step 732, last minute booking system(s) 120 may query the event excess capacity system 112 for one or more events having excess capacity. In response, the event excess capacity system 112 may provide excess capacity information of the event(s) at step 734. The last minute booking system(s) 120 may use the information to assist potential customers make reservations for event(s) with excess capacity.

At step 736, the event excess capacity membership management system 122 may dynamically generate and/or update a queue in a ranked order. The queue may be a list of members who want to attend an event. The ranked order may use a variety of algorithms for determining how to rank the members, including “first come, first serve,” membership level (e.g., bronze, silver, gold), number of uses during a calendar year, “personal” factor(s) (e.g., birthday, anniversary, school or other reunions, etc.), number of members seeking to attend an event, number of relationship members seeking to attend an event, or any other factor that may be used to adjust rank of a member on the queue for the event. At step 738, the event excess capacity membership management system 122 may be configured to communicate status of the event request to the electronic device(s) 702 of the event member(s). The communication may provide a member with a current ranking for an event along with a total number of available seats (or other excess capacity measure) for one or more events. As an example, in the case of a member seeking to travel on an airline on a particular day, the communication may include a ranking of the member for each of the different flights along with an amount of excess capacity for each of the flights, thereby enabling the member to select from the flights with the calculated or estimated number of available seats available at the time. In selecting the flights, depending on the amount of excess capacity, the event excess capacity membership management system 122 may determine which, if any, of the flights that the member may be able to be booked and present those flights to the member for selection. Because the membership provides for usage of excess capacity for events, the system 122 (and/or other systems) may provide an estimate or prediction for the member(s) to be able to attend an event, and booking by the event reservations system(s) 110 may be limited or qualified (e.g., standby status).

At step 742, the event reservations system(s) 110 may update an event customer list and excess capacity list to include the reservation for the member. Again, the reservation may include listing the member on a standby list or other excess capacity list. At step 744, the event reservation system(s) may communicate with the event management system 108 to request that the member be added to an event itinerary (e.g., list of attendees), by name, by headcount, or otherwise so that the event operator knows that an event excess capacity member has been added to be attending the event. At step 746, the event reservation system(s) 110 may communicate with the event excess capacity system 112 to cause the event excess capacity system to update records for an event. Alternatively, the event management system 108 may communicate with the event excess capacity system 112 to cause the event excess capacity system to update records for an event. At step 748, the process may be repeated until a pre-event window closes. As understood in the art, event operators may establish a window for closing ticket sales, and after the window closes, standby tickets may be purchased. At the time that the window closes, the event excess capacity member(s) may be notified via an electronic communication, for example, whether the member will be able to attend the desired event. It should be understood that the process 700 is illustrative, and that alternative configurations for providing the features and methodologies may be utilized, as well.

TABLE I
Event Capacity Lists

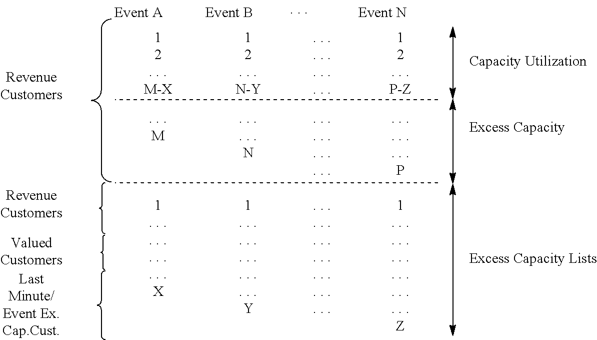

A table showing multiple events with varying amounts of excess capacity available to be filled by members of an event excess capacity membership is shown. Event A has a capacity of N customers, Event B has a capacity of M customers, and Event N has a total capacity of P customers. Each of the events has a certain amount of capacity utilization (i.e., customers who actually attend the event), and has a certain amount of excess capacity (i.e., available seating or space for additional customers to attend the respective events). Because there is excess capacity for each of the events, excess capacity lists are established for each of the events, where the excess capacity lists may be filled by last minute customers, event excess capacity customers, or revenue customers who were previously attending a different event (e.g., travelers who want to change flights or those willing to pay for the excess capacity). In general, after a cutoff time, the excess capacity may be filed with event excess capacity customers, and that capacity may be filled using a list of excess capacity customers in a ranked order. As previous described, the ranked order may be “first come, first serve,” using a weighting factor, using personal factor(s), using status, or any other factor by which a manager of an event excess capacity membership may utilize.

Revenue customers may be those customers who have paid money for attending an event. The revenue customers may be categorized based on amount of amount of money paid for attending the event, use compensation by the event operator (e.g., frequent flyer miles), or otherwise. As shown, the number of revenue customers for the different events may be different (e.g., M revenue customers, N revenue customers, and P revenue customers, where the capacity for each event is defined by number of seats, fire marshal, or otherwise). Capacity utilization for each of the events may be M-X, N-Y, and P-Z, where X, Y, and Z are excess capacity values and define the difference between maximum capacity and capacity utilization. As an example, for Event A, if M=200 and X=12, the maximum capacity is 200, capacity utilization is 188, and excess capacity is 12.

As shown, excess capacity lists may be established for each event. The excess capacity may be filled by an event operator by selling additional capacity to new revenue customers, rebook revenue customers from a different event (e.g., airline passengers who were scheduled on a different flight), with valued customers (e.g., frequency flyer passengers who redeem their miles), last minute customers (e.g., customers who purchase tickets through last-minute resellers), and event excess capacity customers who are excess capacity members. Depending on the type of event, the event capacity lists may be basic, such as filled by only revenue customers (e.g., sporting events), filled by revenue customers and event excess capacity customers (e.g., sporting events), filled by revenue customers, valued customers, last-minute customers, and event excess capacity customers (e.g., airline flights, hotel rooms, etc.). As shown, each of the lists may

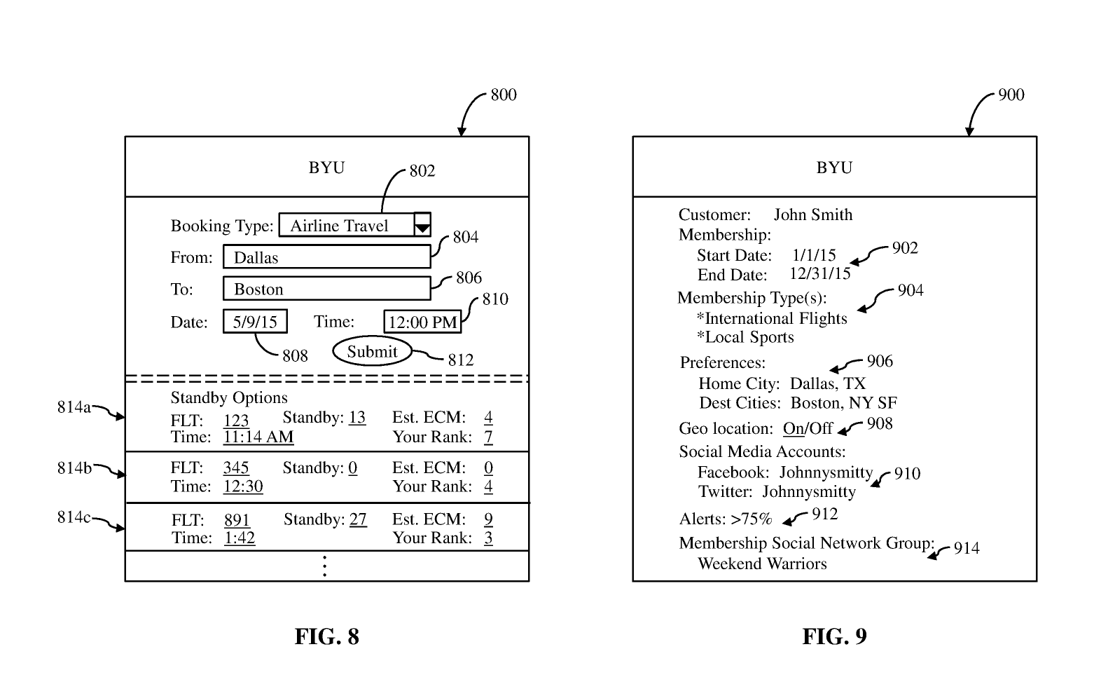

With regard to FIG. 8, a screen shot of an illustrative graphical user interface 800 by which a member of an event excess capacity membership can search for availability of an event, in this case an air travel event is shown. The user interface 800 may include a booking type selection element 802 that enables a user to select a booking type, such as airline travel. Other booking types, such as hotel, rental car, cruise ship, train, shuttle service, or other transportation or hospitality service may be available for a user to select. In the case of selecting airline travel, the user may be provided with entry or selection fields 804 and 806 for traveling from and to locations (e.g., from Dallas to Boston). The user may also be provided with a date entry or selection field 808, time field 810, and “submit” soft-button 812 that allows the user to submit a search request.

In response to the search, events 814a-814c (collectively 814), in this case flights that meet the search parameters, may be displayed for the user to view and, optionally, select to reserve a standby spot on the flight. It should be understood that alternative booking types may provide for alternative selection or entry fields that are typically used for the other booking types. In this case, the user interface 800 is meant to be used by an event excess capacity member, such that search results may not show cost for attending the event, but rather an amount of excess capacity, generally known as “standby” for air travel. The standby options 814 are shown to include flight number, standby availability (i.e., excess capacity), estimated excess capacity member availability (“Est. ECM”), and “your rank,” where “your rank” refers to the rank of the member within the estimated excess capacity member availability. The excess capacity member availability is estimated based on excess capacity for an event minus an estimated number of revenue members who will fill the excess capacity minus an estimated number of valued customers who may fill the excess capacity minus an estimated number of last-minute revenue customers. In the event 814a, four (4) estimated excess capacity member spots are available and the customer is ranked at number seven (7). As a result, the likelihood of the excess capacity member to be able to book the event 814a is low, while event 814c has nine (9) estimated excess capacity member spots, and the member's rank is three (3), so that the member will likely be able to book the event 814c.

With regard to FIG. 9, a screen shot of an illustrative graphical user interface 900 of a profile of a member to participate in excess capacity of events is shown. The user interface 900 may include membership start and end dates 902, membership type(s) 904 (e.g., international flights, local sports), preferences (e.g., home city, desired destination cities), geolocation (e.g., GPS) preference, social media account names 910, alerts (when over a certain chance of being able to attend an event) 912, and membership social network group 914. The membership social network group 914 may be a group of members within the membership who desire to take trips together, so that when the group desires to travel, that group may receive a temporary rank increase (e.g., add 10 points) to improve their collective and individual chances of being able to be place on a flight or otherwise participate in an event. The profile may include a variety of additional preferences and information associated with a member that enables the system to automatically identify event opportunities for the member that (i) matches his or her profile and preferences and (ii) ensures that event opportunities are relevant to the member (e.g., if the member is currently located in a different city or country as determined by geolocation, then the system will not identify event opportunities in different geolocations (e.g., home city).

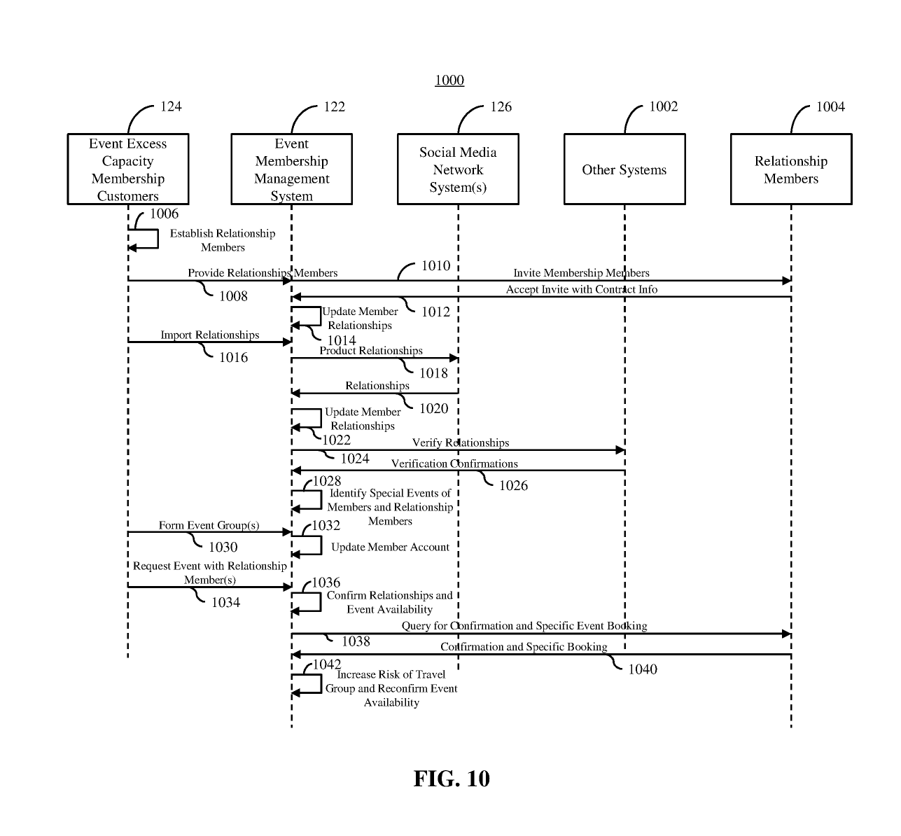

With regard to FIG. 10, an interaction diagram inclusive of an illustrative process 1000 that provides for excess capacity membership customers to invite relationship members to an event with excess capacity is shown. The process 1000 is shown to include the event excess capacity membership customers 124, event excess capacity membership management system 122, social media network system(s) 126, other systems 1002, and relationship members 1004. The process starts at step 1006, where the event excess capacity membership customers 124 may establish relationship member. The relationship members may be other event excess capacity members with whom members want to be affiliated and participate in events. By enabling such relationships, higher membership may result, thereby improving revenue and utilization for the event operator. For example, if there is going to be excess capacity on a flight, multiple members may collectively participate in the event, thereby increasing sales of related products and services during the event. At step 1008, relationship members may be provided to the event excess capacity membership management system 122, which may electronically communicate an invite to the relationship members 1004. The relationship members 1004 may receive and accept the invite with contact information (e.g., phone number, email address, etc.). At step 1014, the system 122 may update member relationships. At step 1016, the customers 124 may import relationships via the system 122, and, in response, the system 122 may communicate with the social media network system(s) 126 at step 1018, and the system(s) 126 may communicate the relationships at step 1020. The relationships may be relationships that the customers have on social media systems (e.g., Facebook®, Twitter®, etc.). The relationships may include names, electronic addresses, or otherwise.

At step 1024, the relationships 1024 may be verified with other systems 1002. The other systems 1002 may include public records and/or private records that can verify specific information about the relationships. In one embodiment, the other systems 1002 may be used to verify address information. In another embodiment, criminal records may be verified depending on the types of events that the relationship members are to attend. At step 1026, the other systems 1002 may provide verification confirmations, which may include both verification of the request along with any additional information that was requested, such as current address, current location (e.g., GPS information based on mobile device), etc. In one embodiment, the system 122 may utilize GPS information of a member and/or guest travelers of the member to confirm that the member and his or her guests are, in fact, in the locations for which events are available, thereby improving efficiency of memory utilization, improving efficiency of communications, reducing energy usage, and improving processing.

At step 1028, the system 122 may identify special events of members and re special events may include birthdays, anniversaries, holidays, graduations, reunions, events in which one or more members are to attend, or any other special event that may motivate the excess capacity membership customers 124 to participate in an event (e.g., airline travel). The system 122 may record those special events and use those events to increase ranking of a customer in attempting to attend an event with excess capacity.

At step 1030, the event excess capacity membership customers 124 may interact with the system 122 to form one or more event groups. An event group may be a group of individuals who want to attend an event together, such as a family group, friendship group, religious group, or otherwise. The system 122 may update a member account at step 1032 in response to a customer forming an event group. It should be understood that each member may have and participate in more than one group.

At step 1034, the customers 124 may request to participate in an event with one or more relationship member(s) who may be part of an event group via the system 122. At step 1036, the system 122 may confirm relationships and event availability. In confirming the relationships, the system 122 may confirm that the relationship member(s) 1004 are available to participate in an event. In one embodiment, in determining that the relationship member(s) 1004 are available to participate in an event, the system 122 may confirm that a GPS position of a relationship member is suitable to attend an event, may check with an electronic calendar of respective relationship member(s) 1004, or otherwise enable the relationship member(s) to respond to an electronic request to the relationship members 1004 prior to enabling the customer(s) 124 to book an event. At step 1042, if a group of members are to attend an event, the system 122 may increase rank of the event group and reconfirm event availability. In increasing the rank, the system 122 may increase the rank by assessing the ranking of each of the individual members of the group to determine an overall ranking of the group. The ranking of the members of the group may be increased temporarily for the event as a group may be more beneficial to an event operator than individuals or smaller groups. As an example, if a travel group decides they want to spend a weekend in London, a travel group with individuals from various geographic regions around the world may participate in using their membership to travel to London on one or more airline that participates with the event excess capacity membership customers 124, each of the members in the travel group may have their ranking temporarily increased for the weekend to give each of the members of the travel group a better chance of being able to book flights using excess capacity of the flights. It should be understood that alternative processes and system confirmations may be utilized to provide the same or similar functionality as described herein.

The systems and methods use a specially-programmed computer system that has the capability to perform the complex computations and automated functionality that cannot be reasonably performed by a person. The computations and functionality are envisioned to be performed by a non-human system, including hardware, software, and/or firmware. The computations and functionality require cannot be performed by a generic computer, but rather a specially-programmed computer that is configured to perform the complex computations and functionality described herein. The techniques and processes described herein may also improve the efficiency of the specially-programmed computer by performing discrete tasks that can more optimally process data.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A system, comprising:
a storage unit configured to store (i) an event excess capacity membership group data repository inclusive of membership information associated with each member of the event excess capacity membership group;
a memory unit;
an input/output (I/O) unit configured to communicate over a communications network; and
a processing unit in communication with said memory unit and said I/O unit, and configured to:
query an event management data repository in response to receiving a request from an electronic device of a member of the event excess capacity membership group to participate in an event occurring on a certain date to identify at least one event on the certain date having excess capacity;
identify at least one event on the certain date with excess capacity;
access the event membership data repository to determine whether at least one personal factor exists, the at least one personal factor being both non-event related and non-membership related;
cause an excess capacity rank value of the member to be computed as a function of the event related factors, membership related factors, and personal related factors;
query the event management data repository to determine or estimate how many revenue customers will utilize the excess capacity of the identified at least one event with excess capacity;
dynamically generate and update a queue in a ranked order of members who have requested to attend an event on the certain date; and
communicate to the electronic device of the member that the member is ranked above a capacity threshold level in the queue that is indicative that the member can utilize the excess capacity of the event on the certain date.

2. The system according to claim 1, wherein said processing unit is further configured to:
in response to receiving an identifier associated with each of the members who are in the queue in the ranked order, query the queue to determine that the member is ranked above a capacity threshold level in the queue indicative of the excess capacity being available for each of the members; and
in response to determining that the member is ranked above the capacity threshold level, indicate that the member is authorized to enter the event,
otherwise, indicate that the member is not authorized to enter the event.

3. The system according to claim 1, wherein the at least one personal factor that is both non-event related and non-membership related is a school reunion of a school attended by the member.

4. The system according to claim 1, wherein the at least one personal factor that is both non-event related and non-membership related is religious holiday of a religion of the member.

5. The system according to claim 1, wherein said processing unit is further configured to:
access at least one social media data repository of the member;
identify at least one personal factor of the member from the at least one social media data repository;
determine from the identified at least one personal factor whether a special event is approaching for the member based on the personal factor; and
if a determination is made that a special event is approaching, establishing that the personal related factor has a special event approaching, otherwise, not establishing that the personal related factor has a special event approaching.

6. The system according to claim 1, wherein the at least one event includes airplane flights.

7. The system according to claim 1, wherein said processing unit is further configured to:
store a total number of revenue flights by the members of the excess capacity membership group;
track a total number of excess capacity flights taken by the member; and
apply the total number of revenue flights and excess capacity flights taken by the member in computing the excess capacity rank value.

8. The system according to claim 1, wherein said processing unit is further configured to:
receive geocoordinate information associated with the electronic device of the member;
confirm that the member is in a geocoordinate location to utilize the excess capacity of the event; and
notify the member of the excess capacity.

9. The system according to claim 1, wherein said processing unit, in determining or estimating how many revenue customers will utilize the excess capacity of the identified at least one event with excess capacity, is further configured to determine whether any events that would otherwise service revenue customers were canceled so as to cause revenue customers to attend the at least one event with excess capacity.

10. The system according to claim 9, wherein said processing unit is further configured to automatically notify the member if the rank of the member drops below a level of available capacity for the event.

11. A method, comprising:
querying an event management data repository in response to receiving a request from an electronic device of a member of an event excess capacity membership group to participate in an event occurring on a certain date to identify at least one event on the certain date having excess capacity;
identifying at least one event on the certain date with excess capacity;
accessing the event membership data repository to determine whether at least one personal factor exists, the at least one personal factor being both non-event related and non-membership related;
causing an excess capacity rank value of the member to be computed as a function of the event related factors, membership related factors, and personal related factors;
querying the event management data repository to determine or estimate how many revenue customers will utilize the excess capacity of the identified at least one event with excess capacity;
dynamically generating and updating a queue in a ranked order of members who have requested to attend an event on the certain date; and
communicating to the electronic device of the member that the member is ranked above a capacity threshold level in the queue that is indicative that the member can utilize the excess capacity of the event on the certain date.

12. The method according to claim 11, further comprising:
in response to receiving an identifier associated with each of the members who are in the queue in the ranked order, querying the queue to determine that the member is ranked above a capacity threshold level in the queue indicative of the excess capacity being available for each of the members; and
in response to determining that the member is ranked above the capacity threshold level, indicating that the member is authorized to enter the event,
otherwise, indicating that the member is not authorized to enter the event.

13. The method according to claim 11, wherein the at least one personal factor that is both non-event related and non-membership related is a school reunion of a school attended by the member.

14. The method according to claim 11, wherein the at least one personal factor that is both non-event related and non-membership related is religious holiday of a religion of the member.

15. The method according to claim 1, further comprising:
accessing at least one social media data repository of the member;
identifying at least one personal factor of the member from the at least one social media data repository;
determining from the identified at least one personal factor whether a special event is approaching for the member based on the personal factor; and
if a determination is made that a special event is approaching, establishing that the personal related factor has a special event approaching, otherwise, not establishing that the personal related factor has a special event approaching.

16. The method according to claim 11, wherein the at least one event includes airplane flights.

17. The method according to claim 11, wherein further comprising:
storing a total number of revenue flights by the members of the excess capacity membership group;
tracking a total number of excess capacity flights taken by the member; and
applying the total number of revenue flights and excess capacity flights taken by the member in computing the excess capacity rank value.

18. The method according to claim 11, further comprising:
receiving geocoordinate information associated with the electronic device of the member;
confirming that the member is in a geocoordinate location to utilize the excess capacity of the event; and
notifying the member of the excess capacity.

19. The method according to claim 11, wherein determining or estimating how many revenue customers will utilize the excess capacity of the identified at least one event with excess capacity includes determining whether any events that would otherwise service revenue customers were canceled so as to cause revenue customers to attend the at least one event with excess capacity.

20. The method according to claim 19, further comprising automatically notifying the member if the rank of the member drops below a level of available capacity for the event.
